(19) United States
(12) Patent Application Publication
(10) Pub. No.: US 2016/0002450 A1
(43) Pub. Date: Jan. 7, 2016

(54) RESIN COMPOSITION HAVING EXCELLENT SURFACE SMOOTHNESS

(71) Applicant: FURUKAWA ELECTRIC CO., LTD., Tokyo (JP)

(72) Inventors: Hiroki CHIBA, Tokyo (JP); Koichi MIZUNO, Tokyo (JP); Tomoyuki SHIRAI, Tokyo (JP)

(21) Appl. No.: 14/770,399

(22) PCT Filed: Feb. 25, 2014
(86) PCT No.: PCT/JP2014/054421

§ 371 Date: Aug. 25, 2015

(30) Foreign Application Priority Data
Feb. 27, 2013 (JP) 2013-037155

(51) Int. Cl. C08L 23/12; H01B 3/44; C08L 23/08

(52) U.S. Cl. CPC C08L 23/12; C08L 23/08; H01B 3/441

(57) ABSTRACT

Solved is the following problem: a polyolefin resin including a film grade ethylene-α-olefin copolymer is excellent in economic efficiency, but has a narrow molecular weight distribution in consideration for strength and heat sealability, and therefore causes surface roughening to occur when applied to a covering material for an insulated electric wire or cable. Used is a polyolefin based resin composition in which, when the ratio (I₁₀/I_{0.5} ) of the melt flow rate (MFR) (I₁₀) measured at 190° C. and a load of 10 kg to the MFR (I_{0.5}) measured at 190° C. and a load of 0.5 kg is defined as MFRR, MFRR≧43 is satisfied.

### TECHNICAL FIELD

The present invention relates to a resin composition for covered electric wire and cable to be produced by extrusion, and relates to a resin composition for protection and insulation of electric wire and cable, which can allow to produce covered electric wire and cable having a high economic efficiency and being excellent in surface smoothness while electric, thermal, dynamic and chemical properties are not impaired. The present invention also relates to a technique for applying a film grade polyolefin based resin to an insulating material or a cable sheath material of a covered electric wire.

### BACKGROUND ART

While electric wire and cable are, of course, used for a power transport medium, the amount thereof to be used for an information transmission medium is also remarkably increased in accordance with development of the information society and electronization of every equipment. Therefore, a plastic material that protects and insulates electric wire and cable is demanded to have a key role in allowing power transport and information transmission to function safely.

The power transport medium is divided to, for example, a transmission line that transmits electricity generated in a power plant to an electrical substation of a point of consumption, a distribution line that distributes electricity, whose voltage is reduced to a predetermined value at the electrical substation, to a factory, a building, a home or the like, furthermore, wiring for use in a factory, a building, a home or the like, and an electric wire for specialized equipment, for use in boat and ship, an airplane, an automobile or the like. On the other hand, examples of the information transmission medium include an optical cable for use in a main line between telephone stations, an optical and metal code/cable for use in a telephone station, an optical and metal cable for wiring between power poles, a cable to be drawn in a house, electric wire and cable for connection between electronic equipment in an office or a home, and a code for connection between audio-video equipment such as television. In recent years, the amount of electric wire and cable to be used in an electronic automobile has also been increased.

The protective insulating material for electric wire and cable of the present invention is mainly directed to the field of a distribution line of several hundreds V or less in power transport, and the fields of an optical cable for a main line, an optical and metal cable for local wiring, and code and cable for connection between electronic equipment in an office or a home, in information transmission, and three kinds: a vinyl chloride (PVC) resin, a polyethylene (PE) resin and a crosslinked PE resin; are mainly used currently in terms of properties and a cost. In such applications, while the protective insulating material is demanded to accomplish original objects with respect to electric insulation, protection and anticorrosion properties of an electric wire, and ease of handling of an electric wire and a cable, it is also demanded to be excellent in aesthetic appearance, low in cost (economic efficiency), efficient in covering (productivity) and compatible with the environment. The protective insulating material for electric wire and cable of the present invention is also of importance in terms of thermal and chemical properties such as impact resistance, wear resistance, weather resistance and oil resistance because of also being applied to a sheath layer for protection from the external environment to be provided in addition to an electric insulating layer provided on a conductor.

PE bearing such essential physical properties demanded for a protective insulating material for electric wire and cable has been studied from various viewpoints over many years. Such studies are closely related to the history of the development of PE (Non Patent Literatures 1 to 3). A large factor for them is also that PE is used in large amounts mainly in a packaging material or the like and is a material that is inexpensive and excellent in economic efficiency. An additional factor for them is that PE has been recently expected as an alternative material for PVC because of being free of halogen that causes a harmful substance to be generated.

Low density PE (LDPE) by a high pressure process, industrially produced in the 1930's, has been widely used as a protective insulating material for electric wire and cable because of being excellent in extrudability, having no problem in terms of outer appearance and having flexibility, but has been problematic in terms of wear resistance, weather resistance and the like.

In response to such a problem, application of high density PE (HDPE) with a Ziegler-Natta catalyst system industrially produced in the 1950's has been tried. HDPE has been, however, poor in extrudability to cause the problem in terms of outer appearance: surface roughening, referred to as melt fracture. In particular, such a problem has been remarkably caused in production at a high speed, making impossible to increase productivity. Therefore, as disclosed in Japanese Patent Laid-Open No. 58-111205 and Japanese Patent Laid-Open No. 61-148703, such a problem has been tried to be solved by a method of mixing HDPE with a polyolefin based resin having a different melt viscosity behavior, such as LDPE.

In the 1970's, linear LDPE (LLDPE) industrially produced by a gas phase polymerization process in the U.S., in particular, LLDPE produced by copolymerization of ethylene with α-olefin through a Ziegler-Natta catalyst has been excellent in mechanical strength, heat resistance and hot sealability as compared with LDPE, and has been superior in sealing strength, impact resistance, hot tack property and the like as compared with Surlyn (registered trademark, PE ionomer), and therefore conventional LDPE has been substituted with LLDPE mainly in a packaging material application. LLDPE, having a short-chain branched structure, has been expected as a material falling between linear HDPE almost not branched and LDPE having many long chain branches, which covers the shortcomings of both of them, also in an application of a protective insulating material of electric wire and cable. LLDPE, however, having the problem in terms of outer appearance referred to as melt fracture as in HDPE, has been improved by a method of mixing with LDPE or a different kind of LLDPE as disclosed in, for example, Japanese Patent Laid-Open No. 60-110739 and Japanese Patent Laid-Open No. 6-52719.

Furthermore, LLDPE produced by copolymerization of ethylene with α-olefin through a metallocene catalyst developed by Professor Kaminsky et al. in 1980, having a narrower molecular weight distribution and being more excellent in low-temperature sealability and strength than the above LLDPE, has been industrially produced in the 1990's and has been necessary as a packaging material in the 2000's, and the amount of LLDPE to be used in a film application has been enormous. In particular, application to a protective insulating material for electric wire and cable has been studied in terms of economic efficiency, but a special melt viscosity behavior generated by a narrow molecular weight distribution has caused the problem of melt fracture in extrusion to be remarkable, and there have been made improvements by the development of LLDPE having a new branched structure as disclosed in, for example, National Publication of International Patent Application No. 1995-500622 and National Publication of International Patent Application No. 2000-508466, and by mixing of a different polyolefin based resin, a thermoplastic elastomer (TPE) and the like as disclosed in Japanese Patent Laid-Open No. 2007-177183 and the like.

Japanese Patent Laid-Open No. 6-52719 has disclosed the physical property value where no melt fracture is caused, in definition of the ratio of the melt flow rate (MFR) (I_{21.6}) measured at 190° C. and a load of 21.6 kg to the MFR (I_{2.16}) at 190° C. and a load of 2.16 kg as the melt flow rate ratio (MFRR) according to JIS K 7210, but only formation of a sheet by pressing has been performed and the above problem in terms of outer appearance of covered electric wire and cable has not still been solved. In fact, as described later, it has been found that a resin composition which can solve the problem of melt fracture in production at a high linear speed has an increased discharge speed under conditions of 190° C. and 21.6 kg to make precise measurement impossible.

National Publication of International Patent Application No. 1995-500622 and National Publication of International Patent Application No. 2000-508466 have disclosed the physical property value where no melt fracture is caused, in definition of the ratio (I₁₀/I₂) of the MFR (I₁₀) measured at 190° C. and a load of 10 kg to the MFR (I₂) measured at 190° C. and a load of 2 kg as the melt flow rate ratio (MFRR) according to ASTM D-1238. In the former case, 5.63≦I₁₀/I₂ is satisfied, and in the latter case, 7.0≦I₁₀/I₂≦16.0 is satisfied. In the former case, however, only film processing has been performed, and no evaluation as a material for covering electric wire and cable has been performed. In the latter case, while the electric wire-covering test has been performed, the visual evaluation results have been merely quantified, and the degree of surface roughness has not been seen and furthermore the improvement effect with such quantification has been only about 20%.

The MFRRs according to JIS K 7210 and ASTM D-1238 are set for roughly providing various processing conditions, and are not set for the purpose of solving the problem of melt fracture in production of covered electric wire and cable by extrusion using a polyolefin based resin composition mainly including PE. Accordingly, a resin composition identified by the MFRRs under such measurement conditions does not solve the problem of melt fracture.

That is, even various improvements described above have not provided a polyolefin based resin composition mainly including a PE based resin, which can simultaneously solve the problem in terms of physical properties such as wear resistance and weather resistance and the problems in terms of outer appearance (surface smoothness) and economic efficiency, and no melt viscosity behavior suitable for extrusion has been identified.

### CITATION LIST

### Patent Literatures

Patent Literature 1: Japanese Patent Laid-Open No. 58-111205
Patent Literature 2: Japanese Patent Laid-Open No. 61-148703
Patent Literature 3: Japanese Patent Laid-Open No. 60-110739
Patent Literature 4: Japanese Patent Laid-Open No. 6-52719
Patent Literature 5: National Publication of International Patent Application No. 1995-500622
Patent Literature 6: National Publication of International Patent Application No. 2000-508466
Patent Literature 7: Japanese Patent Laid-Open No. 2007-177183

### Non Patent Literatures

Non Patent Literature 1: Recent Trend and Near Future Direction of Plastic Material Technology in Progress of High Functionalization, edited by Takeo YASUDA, Industrial Material, vol. 53, No. 4, 18 (2005)
Non Patent Literature 2: Prospect of Japan Plastic Industry in 2006, “Polyethylene”, Plastic Editorial Department, Plastics, 57 (1), 27 (2006)
Non Patent Literature 3: Latest Trend of Metallocene Polyethylene, edited by Takuya SERI, Convertech, 32 (10), 76 (2004)
Non Patent Literature 4: Engineering Plastics—Characteristics and Processing, edited by Yasushi OYANAGI, p.p. 74 (1985)
Non Patent Literature 5: Polymer Chemistry Introduction, edited by Seizo OKAMURA (and other six persons) (second edition), p.p. 155 (1981)

### SUMMARY OF INVENTION

### Technical Problem

An object of the present invention is to provide a protective insulating material that can solve the problem of melt fracture caused in application of a film grade polyolefin based resin for use mainly in a packaging material and the like to production of covered electric wire and cable by extrusion, that can have economic efficiency and productivity while physical properties demanded for covered electric wire and cable are not impaired, and that can be used to produce covered electric wire and cable excellent in surface smoothness.

Another object of the present invention is to provide a polyolefin based resin composition having melt viscoelasticity, which enables to exhibit surface smoothness when applied to extrusion as a protective insulating material for covered electric wire and cable.

### Solution to Problem

The present inventors have found that, when the ratio (I₁₀/I_{0.5}) of the MFR (I₁₀) measured at 190° C. and a load of 10 kg to the MFR (I_{0.5}) measured at 190° C. and a load of 0.5 kg is defined as MFRR, a polyolefin based resin composition having an MFRR of 43 or more is a protective insulating material that can have economic efficiency and productivity and that enables to exhibit excellent surface smoothness while physical properties demanded for a covered electric wire (including insulated electric wire and cable) are not impaired, and have completed the present invention as a technical idea.

Such a polyolefin based resin composition of the present invention is not particularly limited as long as the MFRR is achieved, but preferably includes two or more polyolefin based resins. It has been found that, in particular, a polyolefin based resin composition including at least one PE based resin of a film grade ethylene-α-olefin copolymer and having an MFRR of 43 or more can allow a resin covered electric wire (including insulated electric wire and cable) excellent in surface smoothness to be produced.

### Advantages Effects of Invention

According to the present invention, a polyolefin based resin including a film grade ethylene-α olefin copolymer can be applied to a protective insulating material for covered electric wire and cable.

Moreover, according to the present invention, covered electric wire and cable can be provided which is high in productivity, in addition to economic efficiency, and are excellent in aesthetic outer appearance because not only a polyolefin based resin composition excellent in economic efficiency can be used, but also there is caused no problem of melt fracture even in production at a high speed.

### BRIEF DESCRIPTION OF DRAWINGS

FIG. 1 is a graph in which the arithmetic average roughness (Ra, μm) and the MFRR (I₁₀/I_{0.5}) are plotted on the vertical axis and the horizontal axis, respectively, based on the results in Table 2.

FIG. 2 is a graph in which the arithmetic average roughness (Ra, μm) and the MFRR (I₁₀/I₂) are plotted on the vertical axis and the horizontal axis, respectively, based on the results in Table 2.

### DESCRIPTION OF EMBODIMENTS

Hereinafter, embodiments of the present invention are described.

The present inventors have considered in the course of investigation of the relationship between the melt viscosity behavior and the melt fracture of each of various resin compositions that, while the MFRRs disclosed in National Publication of International Patent Application No. 1995-500622 and National Publication of International Patent Application No. 2000-508466 cannot allow the above problems to be solved, it is significant to focus on the physical property value MFRR related to the regularity of a molecular structure and a proper MFRR can be defined to thereby allow the above problems to be solved.

This is because the present inventors considered that the problem of melt fracture in extrusion of covered electric wire and cable obtained by extrusion using a polyolefin based resin composition is presumed to be caused as follows and the following is closely related to the MFRR.

First, while there are various theories about the cause of melt fracture by extrusion, it is known that melt fracture occurs physically when the shear stress on the wall surface of a die nozzle excesses the critical shear stress of a resin, and this is presumed to be caused based on the following. The first theory is that high speed extrusion causes uneven convection to occur near a nozzle inflow part. The second theory is that the difference in molecular orientation in the nozzle between the periphery portion in contact with the wall surface of the nozzle and the inside out of contact with the wall surface of the nozzle causes the difference in shrinkability between the periphery and the inside. In addition, the third theory is that a stick-slip phenomenon occurs due to friction with the wall surface of the die. On the other hand, it is presumed with the rheological consideration that, when a polyolefin based resin composition molten in an extruding machine is discharged outside through a nozzle of the extruding machine, the normal stress effect specific to a viscoelastic body is exerted to provide a large and protuberant form, and the temperature of the resin composition is rapidly dropped to result in solidification, causing the protuberant form by the normal stress effect to remain. This is understood from the following: melt fracture is more drastically caused in HDPE and LLDPE than LDPE due to a higher speed of the solidification, and furthermore in HDPE and LLDPE having a narrower molecular weight distribution by use of a metallocene catalyst than LDPE. In particular, as in production of covered electric wire and cable, the Baras effect that is a specific swelling phenomenon observed in pore extrusion (Non Patent Literature 4) is more remarkably exerted in high speed extrusion for an increase in productivity.

While this is based on the regularity of a primary molecular structure associated with the branch structure and the molecular weight distribution of each of LDPE, LLDPE, LLDPE with a metallocene catalyst system, and HDPE, as described above, it is considered to be important to focus on rheology, in particular, a melt viscoelasticity behavior as a macro physical property with respect to the objects of the present invention related to the forming technique of a polymer as a viscoelastic body. In particular, in the case of a resin having a broad molecular weight distribution, it is known that a low molecular component can serve as a lubricant to result in the change in melt viscoelasticity behavior, thereby suppressing melt fracture.

Then, the present inventors have focused on the MFRR reported to have a correlation with the molecular weight distribution, namely, the regularity of a molecular structure, and have made studies based on the following: the MFRR can be defined by an optimal condition to thereby allow the correlation between the viscoelasticity behavior and the regularity of a molecular structure in application of the shear stress to be grasped, solving the problem of melt fracture in extrusion. The reason why the present inventors have focused on the MFRR is because the viscoelasticity behavior can be simply evaluated unlike gel permeation chromatography (GPC), a rheometer and the like.

The present inventors have used various polyolefin based resins, have measured MFRs under various conditions and have made detailed studies about the surface smoothness of a covered electric wire obtained by extrusion, and as a result, have found that it is optimal to use the ratio (I₁₀/I_{0.5}) of the MFR (I₁₀) measured at 190° C. and a load of 10 kg to the MFR (I_{0.5}) measured at 190° C. and a load of 0.5 kg as MFRR.

MFRR=I₁₀/I_{0.5} defined in the present invention is based on an improvement in extrusion pressure of a resin in measurement of the MFRs of MFRR=I_{21.6}/I_{2.16} and MFRR=I₁₀/I₂ disclosed in Japanese Patent Laid-Open No. 6-52719 and National Publication of International Patent Application No. 2000-508466, respectively. First, a resin composition that can overcome melt fracture has the following problem: I_{21.6} cannot be precisely measured. The present inventors have also found that the range of a load in measurement of the MFR in I₂ is too narrow.

This is based on the following: the viscoelasticity behavior is expressed as a function of the experimental time and also as a function of the temperature and such functions are correlated (Non Patent Literature 5). Qualitatively, it is indicated that a higher speed of the stress applied to a viscoelastic body such as a resin corresponds to an effect of decreasing the temperature of the resin, and on the contrary, it is indicated that a lower speed of the stress applied to the resin corresponds to an increase in the temperature of the resin to be applied the stress.

When this is considered with respect to the MFR, it can be said that, when the load is larger, the discharge speed of the resin is higher and such a behavior corresponds to the viscoelasticity behavior at a lower temperature of the resin, and when the load is smaller, the discharge speed of the resin is lower and such a behavior corresponds to the viscoelasticity behavior at a higher temperature of the resin.

Accordingly, the MFRR defined in the present invention, which is the ratio of the MFR at a load of 0.5 kg to that at a load of 10 kg, means that the viscoelasticity behavior is evaluated in a wider temperature range than that of the prior art. Then, it has been found that a resin composition having melt viscoelasticity satisfying this new MFRR can reduce melt fracture.

That is, the present invention can be defined by a polyolefin based resin composition in which, when the ratio (I₁₀/I_{0.5}) of the MFR (I₁₀) measured at 190° C. and a load of 10 kg to the MFR (I_{0.5}) measured at 190° C. and a load of 0.5 kg is defined as MFRR, the MFRR is 43 or more, and insulated electric wire and cable produced using the polyolefin based resin composition.

The following can be used for the polyolefin resin, but any resin satisfying MFRR (I₁₀/I_{0.5})≧43 may be used, and one polyolefin resin or a mixture of two or more polyolefin resins may be used without particular limitation.

In the case of the mixture of two or more polyolefin based resins, at least one PE based resin is preferably used, and each of HDPE, LLDPE, MDPE and LDPE can be used.

In consideration for economic efficiency, however, a film grade PE based resin, in particular, a mixture of two or more polyolefin based resins including at least one ethylene-α-olefin copolymer is preferable. The two or more polyolefin based resins more preferably include at least one PP based resin. As the PP based resin, one having an MFR (at 190° C. and a load of 2.16 kg) of 1 to 100 g/10 min, or more, is further preferably used.

In particular, examples of the ethylene-α-olefin copolymer in the present invention include a copolymer of ethylene with an α-olefin having 4 to 12 carbon atoms, and a copolymer with an α-olefin such as 1-butene, 1-hexene, 4-methyl-1-pentene, 1-octene, 1-decene and 1-dodecene is used. Such a copolymer is preferably, for example, LDPE, LLDPE, MDPE, and LLDPE synthesized with a metallocene catalyst system, more preferably film grade one.

The resin density of the ethylene-α-olefin copolymer in the present invention is, but not particularly limited, preferably 0.880 to 0.940 g/cm³. In the case of such a resin density, flexibility, low-temperature impact resistance, and the like of an insulated electric wire or cable can be achieved.

Examples of a commercial product of the ethylene-αolefin copolymer in the present invention can include “Kernel” (trade name, produced by Japan Polyethylene Corporation), “Evolue” (trade name, produced by Prime Polymer Co., Ltd.), “Moretec” (trade name, produced by Prime Polymer Co., Ltd.), HONAM UF315 (trade name, produced by Honam Petrochemical Corp.), HONAM UF927 (trade name, produced by Honam Petrochemical Corp.), Suntec (trade name, produced by Asahi Kasei Chemicals Corporation), Umerit (trade name, produced by Ube-Maruzen Polyethylene), Sumikasen (trade name, produced by Sumitomo Chemical Co., Ltd.) and Nipolon (trade name, produced by Tosoh Corporation).

A PP based resin is preferably selected as a resin other than the PE based resin in a mixture of the two or more polyolefin based resins. The ratio thereof to be compounded is preferably PE based resin: PP based resin=97 to 50:3 to 50 (parts by mass), further preferably 95 to 80:5 to 20 (parts by mass). Such a compounding ratio can provide a resin composition having melt viscoelasticity suitable for extrusion, resulting in a reduction of melt fracture without causing physical properties demanded for covered electric wire and cable, such as flexibility and cold resistance, to be impaired.

For the PP based resin, a propylene homopolymer (homo PP resin), an ethylene-propylene random copolymer, an ethylene-propylene block copolymer, and the like can be used. A copolymer with 1-butene and a terpolymer with ethylene and 1-butene can also be used. The random copolymer here refers to one in which a component other than propylene is randomly incorporated in the propylene chain in a content of about 1 to 5% by mass. In addition, the block copolymer here refers to one having a sea-island structure in which a component other than propylene is independently present in the propylene component in a content of about 5 to 15% by mass.

The MFR (JIS K 7210, at 190° C. and a load of 2.16 kg) of the PP based resin is preferably 1 to 100 g/10 min, more preferably 5 to 80 g/10 min, further more preferably 10 to 63 g/10 min. A PP based resin having such an MFR value can be compounded in at least one PE based resin to thereby not only make the molecular weight distribution broader, but also break the regularity of the entire composition due to a different component mixed, resulting in an increase in MFRR (I₁₀/I_{0.5}).

Examples of a commercial product of such a PP based resin include products such as “Novatec PP” (trade name, produced by Japan Polypropylene Corporation), “Sunallomer” (trade name, produced by Sunallomer Ltd.) polypropylene, “Noblen” (trade name, produced by Sumitomo Chemical Co., Ltd.) and “Prime Polypro” (trade name, produced by Prime Polymer Co., Ltd.).

Various additives such as an antioxidant, a metal deactivator, a flame retardant (aid), a filler and a lubricant commonly used in an electric wire, a cable, a code, a tube, an electric wire component, a sheet, and the like can be appropriately compounded in the polyolefin based resin composition of the present invention as long as the object of the present invention is not impaired.

Examples of the antioxidant include amine based antioxidants such as polymers of 4,4′-dioctyl diphenylamine, N,N′-diphenyl-p-phenylenediamine and 2,2,4-trimethyl-1,2-dihydroquinoline, phenol based antioxidants such as pentaerythritol-tetrakis(3-(3,5-di-t-butyl-4-hydroxyphenyl)propionate), octadecyl-3-(3,5-di-t-butyl-4-hydroxyphenyl)propionate and 1,3,5-trimethyl-2,4,6-tris(3,5-di-t-butyl-4-hydroxybenzyl)benzene, bis(2-methyl-4-(3-n-alkylthiopropionyloxy)-5-t-butylphenyl)sulfide, 2-mercaptobenzimidazole and zinc salts thereof, and sulfur based antioxidants such as pentaerythritol-tetrakis(3-lauryl-thiopropionate).

Examples of the metal deactivator include N,N′-bis(3-(3,5-di-t-butyl-4-hydroxyphenyl)propionyl)hydrazine, 3-(N-salicyloyl)amino-1,2,4-triazole and 2,2′-oxamidebis-(ethyl 3-(3,5-di-t-butyl-4-hydroxyphenyl)propionate).

Examples of the lubricant include hydrocarbon based, fatty acid based, fatty acid amide based, ester based, alcohol based and metal soap based lubricants, and silicone gum.

The covered electric wire and cable by extrusion using the resin composition are produced as follows. First, additives such as a colorant, an antioxidant and a lubricant are added to the polyolefin based resin, and the resultant is molten and mixed by a Bunbury mixer or an extruder to prepare a polyolefin based resin pellet. Next, this pellet is fed through a hopper, immediately above an extruding machine, into the machine and extruded with being molten by a screw, and a conductor and a covered electric wire are thus covered with the resin composition in a cross head, and discharged.

In the case of the mixture of the PE based resin with other polyolefin based resin, additives such as a colorant, an antioxidant and a lubricant are added to other polyolefin based resin, and the resultant is molten and mixed by a Bunbury mixer or an extruder to prepare a polyolefin based resin pellet. Next, this pellet may be mixed with the PE based resin pellet immediately above an extruding machine, and the resulting mixture may be extruded in the form of an electric wire with being molten and mixed. Alternatively, other polyolefin based resin pellet including the above additives and the PE based resin pellet may be molten and mixed by a Bunbury mixer, an extruder or the like to prepare a resin composition pellet for covering an electric wire in advance. On the contrary, only other polyolefin based resin may be mixed with the PE based resin, naturally or colored, immediately above an extruder and the resulting mixture may be extruded for covering.

On the other hand, the extruding machine for use in production of the covered electric wire and cable of the present invention is not specialized, and a general-purpose extruding machine for production of an electric wire can be used therefor. The temperature of the extruding machine is preferably as follows: the temperature in a cylinder is about 160 to 200° C. and the temperature of a cross head is about 180 to 220° C.

Furthermore, in order to more enhance dynamic, thermal and chemical properties, the covered electric wire may also be subjected to radiation crosslinking in the present invention. γ-Ray and/or electron beam can be used for the source of radiation, conventionally common apparatus and method can be used, and the density of crosslinking is required to be set depending on the intended application.

Hereinabove, the electric wire-covering material of the present invention is mainly directed to the fields of a distribution line of several hundreds V or less in power transport, and a communication cable for connection between stations and an electric wire for connection between electronic equipment in an office or a home in information transmission, but encompasses all with which the periphery of conductors is covered as an electric wire-covering layer, and the structure thereof is not particularly limited. The thickness of the covering layer, the thickness of each conductor, the number of conductors, and the like are not particularly different from conventional ones. These can be appropriately set depending on the type and the application of an electric wire.

### EXAMPLES

Hereinafter, the present invention is specifically described with reference to Examples of the present invention and Comparative Examples.

### [Samples]

Polyolefin based resins used in Examples 1 to 8 and Comparative Examples 1 to 5 were shown in Table 1. An ethylene-1 butene copolymer was used as the film grade ethylene-α-olefin copolymer, and each of h-PP, r-PP and b-PP was used as the PP based resin.

TABLE 1
Samples

| | Abbre- | | | | |
|---|---|---|---|---|---|
| | viations | | | | |
| Compounds | and names | Manufacturers | Grade | MFR | Density |
| Ethylene- | PE based | HONAM | UF-315 | 1.1 | 0.920 |
| α-olefin | resin | | | | |
| copolymer | | | | | |
| PP homo- | h-PP | Sunallomer Ltd. | PM900A | 30 | 0.900 |
| polymer | | | | | |
| PP based | r-PP | Sunallomer Ltd. | PMA20V | 45 | 0.900 |
| random | | | | | |
| polymer | | | | | |
| PP based | b-PP | Sunallomer Ltd. | PMA60Z | 45 | 0.900 |
| block | | | | | |
| polymer | | | | | |

### [Preparation of Resin Composition]

A pellet mixture of the PE based resin and each of the PP based resins was prepared in each compounding ratio shown in Table 2. First, additives such as a colorant, an antioxidant and a lubricant were added to each of the PP based resins, and the resultant was molten and mixed by a Bunbury mixer to prepare each of PP based resin pellets. Next, each of the PP based resin pellets prepared was dry-blended with the PE based resin to provide a pellet mixture of a resin composition for covering an electric wire.

### [Production of Covered Electric Wire]

The pellet of a resin composition for covering an electric wire was fed into an extruding machine for production of an electric wire, and an annealed copper wire having a conductor diameter of 0.8 mm was covered therewith in a thickness of 0.8 mm by extrusion under conditions of cylinder temperatures of 160° C., 170° C. and 210° C. sequentially closer to a feeder, and a cross head temperature of 220° C., to produce a covered electric wire. The speed of the extrusion was 8 m/min.

### [Evaluations]

The MFR of each of the resins was measured at a temperature of 190° C. and each of loads of 10, 2 and 0.5 kg according to JIS K 7210, and the MFRR=I₁₀/I_{0.5} was determined therefrom and the MFRR=I₁₀/I₂ was also calculated for comparison with the prior art.

In addition, with respect to the surface shape of each of the electric wires produced, sampling was made at five points randomly and the surface roughness at each of the sampling points was measured using a surface roughness measurement machine (Surftest SJ-301 manufactured by Mitutoyo Corporation) according to JIS B 0601 to determine the arithmetic average roughness (Ra, μm).

### [Results]

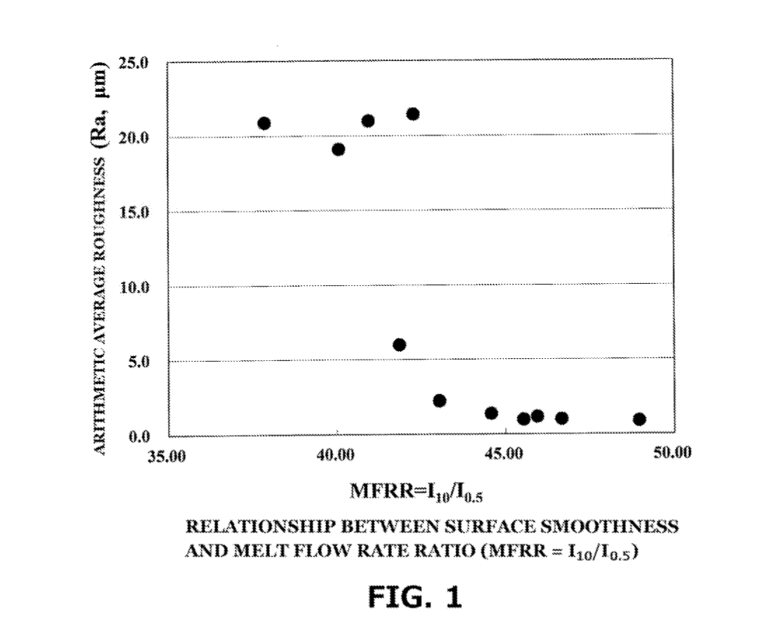

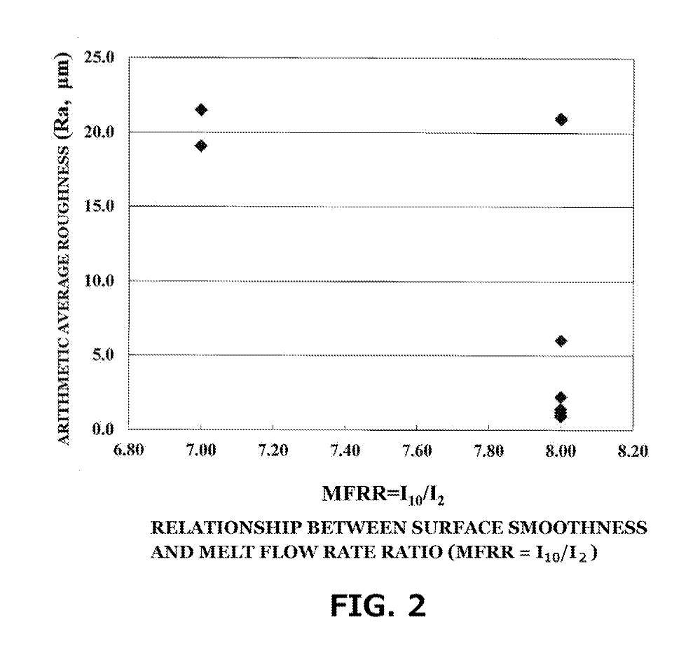

The measurement results were summarized in Table 2. In FIGS. 1 and 2, the arithmetic average roughness (Ra, μm) was plotted on the vertical axis and the MFRR=(I₁₀/I_{0.5}) and MFRR=I₁₀/I₂ were plotted on the horizontal axis based on the results in Table 2.

TABLE 2
Relationship between smoothness and melt flow rate ratio (MFRR)

| | | Com- | Com- | Com- | | | Com- | | | Com- | | |
|---|---|---|---|---|---|---|---|---|---|---|---|---|
| | | parative | parative | parative | | | parative | | | parative | | |
| | | Example 1 | Example 2 | Example 3 | Example 1 | Example 2 | Example 4 | Example 5 | Example 6 | Example 5 | Example 7 | Example 8 |
| UF-315 | | 100 | 99 | 97 | 95 | 90 | 99 | 97 | 95 | 99 | 97 | 95 |
| h-pp | | 0 | 1 | 3 | 5 | 10 | | | | | | |
| r-pp | | | | | | | 1 | 3 | 5 | | | |
| b-pp | | | | | | | | | | 1 | 3 | 5 |
| MFR = I_{0.5} | | 0.2 | 0.2 | 0.2 | 0.2 | 0.3 | 0.2 | 0.2 | 0.2 | 0.2 | 0.2 | 0.2 |
| MFR = I₂ | | 1.1 | 1.3 | 1.3 | 1.3 | 1.5 | 1.3 | 1.3 | 1.4 | 1.3 | 1.3 | 1.3 |
| MFR = I₁₀ | | 8.7 | 9.5 | 9.8 | 10.6 | 12.3 | 9.3 | 9.9 | 11.1 | 8.9 | 9.9 | 10.3 |
| MFRR = I₁₀/I_{0.5} | | 38 | 41 | 42 | 46 | 49 | 42 | 43 | 47 | 40 | 45 | 46 |
| MFRR = I₁₀/I₂ | | 8 | 8 | 8 | 8 | 8 | 7 | 8 | 8 | 7 | 8 | 8 |
| Arithmetic | 1 | 19.2 | 18.0 | 2.6 | 1.0 | 0.7 | 25.0 | 2.1 | 1.0 | 19.7 | 1.0 | 1.0 |
| average | 2 | 21.4 | 28.6 | 6.0 | 1.1 | 1.1 | 19.5 | 1.7 | 1.0 | 8.5 | 2.0 | 1.5 |
| roughness | 3 | 26.3 | 17.1 | 5.3 | 0.9 | 0.7 | 16.0 | 5.3 | 0.9 | 24.1 | 1.1 | 1.1 |
| (Ra, μm) | 4 | 18.4 | 19.8 | 6.2 | 1.1 | 0.9 | 23.7 | 1.3 | 1.0 | 21.1 | 1.5 | 1.4 |
| | 5 | 19.3 | 21.6 | 9.9 | 1.0 | 1.1 | 23.2 | 0.9 | 1.2 | 22.3 | 1.4 | 1.0 |
| | Ave. | 20.9 | 21.0 | 6.0 | 1.0 | 0.9 | 21.5 | 2.2 | 1.0 | 19.1 | 1.4 | 1.2 |

As is clear from Table 2 and FIG. 1, a distinct threshold value of 43 for MFRR=I₁₀/I_{0.5} with respect to the surface roughness could be found. When the MFRR exceeded 43, the surface roughness was rapidly decreased, and was reduced to about a twentieth thereof in calculation of Ra. On the other hand, the MFRR=I₁₀/I₂ was calculated according to National Publication of International Patent Application No. 2000-508466, but no correlation thereof with the surface smoothness was observed at all (Table 2 and FIG. 2). The MFRR=I₁₀/I_{0.5} defined in the present invention is clearly effective.

### INDUSTRIAL APPLICABILITY

The polyolefin based resin composition of the present invention and the covered electric wire and cable produced using the polyolefin based resin composition can be utilized for an insulating material or a sheath material in the wide fields of a distribution line of several hundreds V or less in power transport and an electric wire for connection between electronic equipment in an office or a home in information transmission, in terms of properties and a cost.

In addition, the present invention not only can be expected, with respect to a resin composition for covering an electric wire and a covered electric wire using the resin composition, to sufficiently exhibit superiority in productivity, marketability, functionality and the like in every electrical and electronic equipment industries, in addition to power transport and information transmission industries, but also can be widely applied to an optical code, a power plug, a connector, a sleeve, a box, a tape, a tube, a sheet and the like, and therefore is large in industrial applicability.

1. A polyolefin based resin composition for covering insulated electric wire and cable, wherein, when a ratio (I₁₀/I_{0.5}) of a melt flow rate (MFR) (I₁₀) measured at 190° C. and a load of 10 kg to an MFR (I_{0.5}) measured at 190° C. and a load of 0.5 kg is defined as MFRR, MFRR≧43 is satisfied.

2. The polyolefin resin based composition for covering insulated electric wire and cable according to claim 1, comprising at least two or more polyolefin based resins.

3. The polyolefin based resin composition for covering insulated electric wire and cable according to claim 1, wherein the two or more polyolefin based resins comprise at least one ethylene-α-olefin copolymer and at least one polypropylene (PP) based resin.

4. The polyolefin based resin composition for covering insulated electric wire and cable according to claim 3, wherein an MFR (190° C. and a load of 2.16 kg) of the PP based resin is 1 to 100 g/10 min.

5. A resin covered electric wire, wherein the polyolefin based resin composition for covering insulated electric wire and cable according to claim 1 is used.

6. A resin covered electric wire obtained by mixing the two or more polyolefin based resins recited in claim 2 immediately above an extruder, and feeding the resulting mixture into the extruder for forming.

7. A resin covered electric wire obtained by supplying the PP based resin recited in claim 3 as a pellet of a resin composition comprising at least one of an antioxidant, carbon, a colorant and a lubricant, mixing the pellet with other polyolefin based resin than the PP based resin immediately above an extruder, and feeding the resulting mixture into the extruder for forming.

8. A method for manufacturing a resin covered electric wire comprising mixing the two or more polyolefin based resin recited in claim 2 immediately above an extruder, and feeding the resulting mixture into the extruder for forming.

9. A resin covered electric wire, wherein the polyolefin based resin composition for covering insulated electric wire and cable according to claim 2 is used.

10. A resin covered electric wire, wherein the polyolefin based resin composition for covering insulated electric wire and cable according to claim 3 is used.

11. A resin covered electric wire, wherein the polyolefin based resin composition for covering insulated electric wire and cable according to claim 4 is used.

12. A resin covered electric wire obtained by mixing the two or more polyolefin based resins recited in claim 3 immediately above an extruder, and feeding the resulting mixture into the extruder for forming.

13. A resin covered electric wire obtained by mixing the two or more polyolefin based resins recited in claim 4 immediately above an extruder, and feeding the resulting mixture into the extruder for forming.

14. A resin covered electric wire obtained by supplying the PP based resin recited in claim 4 as a pellet of a resin composition comprising at least one of an antioxidant, carbon, a colorant and a lubricant, mixing the pellet with other polyolefin based resin than the PP based resin immediately above an extruder, and feeding the resulting mixture into the extruder for forming.

15. A method for manufacturing a resin covered electric wire comprising mixing the two or more polyolefin based resin recited in claim 3 immediately above an extruder, and feeding the resulting mixture into the extruder for forming.

16. A method for manufacturing a resin covered electric wire comprising mixing the two or more polyolefin based resin recited in claim 4 immediately above an extruder, and feeding the resulting mixture into the extruder for forming.
